(19) United States
(12) Patent Application Publication
(10) Pub. No.: US 2023/0075112 A1
(43) Pub. Date: Mar. 9, 2023

(54) Deflected Slip Stream Wing System with Coflow Jet Flow Control

(71) Applicants: COFLOW JET, LLC, Cutler Bay, FL (US); UNITED STATES OF AMERICA AS REPRESENTED BY THE ADMINISTRATOR OF NASA, Washington, DC (US)

(72) Inventors: Gecheng Zha, Cutler Bay, FL (US); Siena Whiteside, Hampton, VA (US); Beau Pollard, Hampton, VA (US); Michael Patterson, Hampton, VA (US); Xiaofan Fei, Hampton, VA (US); Paul Rothhaar, Hampton, VA (US); Kevin Antcliff, Hampton, VA (US); Steven Geuther, Hampton, VA (US)

(21) Appl. No.: 17/854,499

(22) Filed: Jun. 30, 2022

Related U.S. Application Data
(60) Provisional application No. 63/217,817, filed on Jul. 2, 2021.

(51) Int. Cl. B64C 21/06; B64C 9/14

(52) U.S. Cl. CPC B64C 21/06; B64C 9/146

(57) ABSTRACT

An example of a deflected slip stream wing system with coflow jet flow control includes a wingbox, a flap, a compressor, and a propulsor. The wingbox has a root and a tip. The flap is moveably attached to the wingbox and has a leading edge, a trailing edge, an injection opening, a suction opening, and a channel. The injection opening is disposed between the leading edge and the suction opening. The suction opening is disposed between the injection opening and the trailing edge. The channel extends from the injection opening to the suction opening. The compressor is disposed within the channel. The propulsor is disposed on the wingbox between the root and the tip. The propulsor has an off state and an on state. When in the on state, the propulsor is aligned relative to the flap such that fluid accelerated by the propulsor contacts the flap.

### RELATED APPLICATION

This application claims the benefit of U.S. Provisional Application No. 63/217,817, filed Jul. 2, 2021. The entire disclosure of this related application is hereby incorporated into this disclosure by reference.

### STATEMENT REGARDING FEDERALLY SPONSORED RESEARCH OR DEVELOPMENT

This invention was made with Government support under contract 80LARC19F0082 awarded by NASA. The Government has certain rights in the invention.

### FIELD

The disclosure relates generally to the field of fluid systems. More particularly, the disclosure relates to deflected slip stream wing systems with coflow jet flow control.

### BACKGROUND

Air transportation vehicles have traditionally made use of propellers or jet engine propulsion systems to generate thrust and wings to generate lift to support the weight of the vehicle. Generally, the propulsion and lift-generating systems have been addressed as separate systems. However, some vehicles have been developed that combine these systems utilizing various structures and technologies in an effort to achieve, for example, vertical takeoff and landing (VTOL).

For example., aircraft have been developed that utilize the flap of a wing to deflect the slip stream of a propulsor to create lift. However, these aircraft have drawbacks, such as insufficient lift due to flow separation, increased noise, and issues in controlling the transition between hover and cruise phases of flight. Other technologies have been developed for fixed-wing VTOL, which include the use of 1) articulating propellers; 2) wings that can be rotated relative to the fuselage; and/or 3) two groups of propulsors in which the first group functions as hover/lift propulsors and the second group functions as forward thrust propulsors. Each of the articulating propeller and rotatable wing concepts utilize actuators to move the propellers/wings, which can increase aircraft weight and complexity. The use of two groups of propulsors results in low cruise efficiency due to carrying unused hover propulsors when in the cruise position, which increases the overall weight and drag of the aircraft. Many other VTOL vehicles that have been contemplated include components that are not used for the entire flight, which reduces overall efficiency.

A need exists, therefore, for new and useful deflected slip stream wing systems with coflow jet flow control that enable more efficient, quiet, and safe VTOL

### Summary of Selected Example Embodiments

Various deflected slip stream wing systems with coflow jet flow control are described herein.

An example embodiment of a deflected slip stream wing system with coflow jet flow control for an aircraft includes a wingbox, a flap, a compressor, and a propulsor. The wingbox has a root and a tip. The flap is moveably attached to the wingbox and has a leading edge, a trailing edge, an injection opening, a suction opening, and a channel. The injection opening is disposed between the leading edge and the suction opening. The suction opening is disposed between the injection opening and the trailing edge. The channel extends from the injection opening to the suction opening. The compressor is disposed within the channel. The propulsor is disposed on the wingbox between the root and the tip. The propulsor has an off state and an on state. When in the on state, the propulsor is aligned relative to the flap such that fluid accelerated by the propulsor is deflected by the wing and the flap.

Additional understanding of the exemplary deflected slip stream wing systems with coflow jet flow control can be obtained by review of the detailed description, below, and the appended drawings.

### BRIEF DESCRIPTION OF THE DRAWINGS

FIG. 1 is a perspective view of an example air transportation vehicle that includes a plurality of deflected slip stream wing systems with coflow jet flow control incorporated into the flaps.

FIG. 2 is another perspective view of the example air transportation vehicle illustrated in FIG. 1 with coflow jet flow control incorporated into the flaps.

FIG. 3 is a partial perspective sectional view of a wing and a deflected slip stream wing system with coflow jet flow control included in the example air transportation vehicle illustrated in FIG. 1.

FIG. 4 is a sectional view of a portion of the deflected slip stream wing system with coflow jet flow control included in the air transportation vehicle illustrated in FIG. 1. The flap with coflow jet flow control is illustrated in a first position for cruise forward.

FIG. 5 is another sectional view of a portion of the deflected slip stream wing system with coflow jet flow control included in the air transportation vehicle illustrated in FIG. 1. The flap with coflow jet flow control is illustrated in a second position for hovering, ascending (takeoff), and descending (landing).

FIG. 6 is a partial sectional view of a 3D model of the deflected slip stream wing system with coflow jet flow control included in the air transportation vehicle illustrated in FIG. 1 subjected to a fluid flow field. The propulsor has been removed for clarity.

FIG. 7 is a perspective view of a suction duct, an injection duct, and a compressor included in the defected slip stream wing system with coflow jet flow control included in the air transportation vehicle illustrated in FIG. 1.

FIG. 8 is a partial sectional view of a model of the deflected slip stream wing system with coflow jet flow control included in the air transportation vehicle illustrated in FIG. 1 subjected to a slipstream fluid flow from the propulsor field.

FIG. 9 is a sectional view of a portion of an alternative deflected slip stream wing system with coflow jet flow control that can be included in an air transportation vehicle. The first flap is illustrated in a second position and the second flap is illustrated in a second position.

FIG. 10 is a partial perspective sectional view of an alternative deflected slip stream wing system with coflow jet flow control that can be included in an air transportation vehicle.

FIG. 11 is a sectional view of a portion of an alternative deflected slip stream wing system with coflow jet flow control that can be included in an air transportation vehicle. The flap is illustrated in a second position.

### DETAILED DESCRIPTION

The following detailed description and the appended drawings describe and illustrate various example embodiments of deflected slip stream wing systems with coflow jet flow control. The description and illustration of these examples are provided to enable one skilled in the art to make and use a deflected slip stream wing system with coflow jet flow control. They are not intended to limit the scope of the claims in any manner. The invention is capable of being practiced or carried out in various ways and the examples described and illustrated herein are merely selected examples of the various ways of practicing or carrying out the invention and are not considered exhaustive.

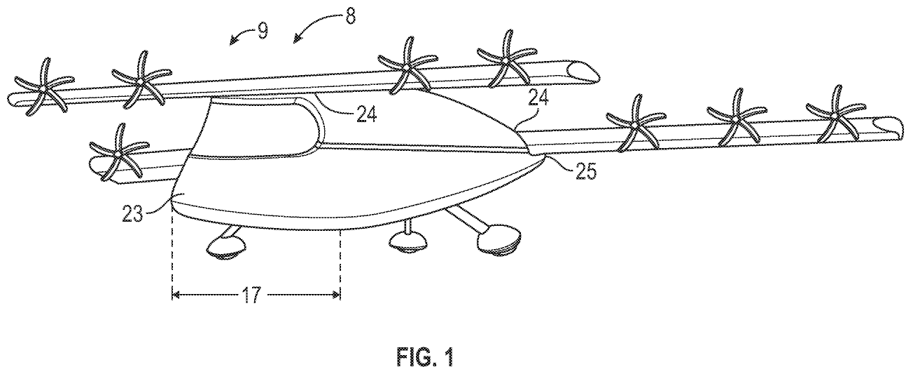

FIGS. 1, 2, 3, 4, 5, 6, 7, and 8 illustrate an example air transportation vehicle 8 that includes a plurality of deflected slip stream wing systems with coflow jet flow control 10. In the embodiment illustrated, the air transportation vehicle 8 is an aircraft 9. However, it is to be understood that the deflected slip stream wing systems with coflow jet flow control 10 described herein can be included on any suitable air transportation vehicle or aircraft in which it is desired to incorporate VTOL capabilities, short takeoff and landing (STOL) capabilities, conventional takeoff and landing (CTOL) capabilities, increased efficiency, and/or noise reduction.

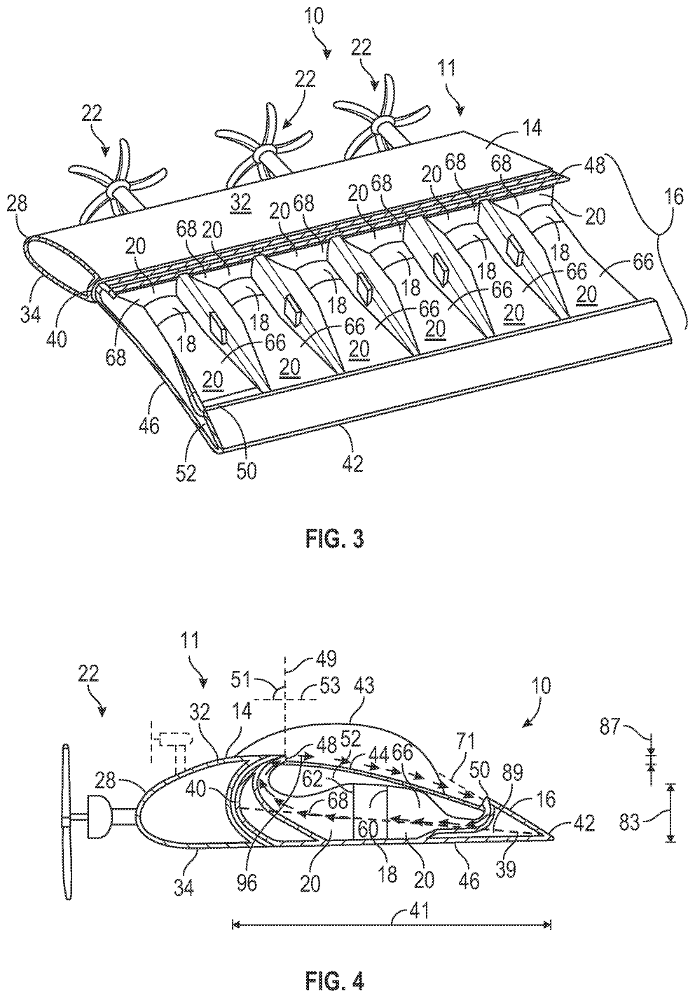

In the illustrated embodiment, the air transportation vehicle 8 includes a fuselage 12 and each of the plurality of deflected slip stream wing systems with coflow jet flow control 10 is attached to the fuselage 12. The fuselage 12 has a lengthwise axis 13, a nose 23, and a tail 25. As shown in FIGS. 3, 4, 5, 6, 7, and 8, each of the plurality of deflected slip stream wing systems with coflow jet flow control 10 includes a wing 11, which includes a wingbox 14 and a flap 16, a plurality of compressors 18, a plurality of ducts 20, and a plurality of propulsors 22. In the embodiment illustrated, the wings 11 are positioned in a tandem wing configuration and the flaps 16 are single plain flaps. The inclusion of a tandem wing configuration provides high hover stability with two lifting vectors. However, alternative embodiments can include a single wing, or a plurality of wings, having any suitable planform and structural arrangement (e.g., span, chord, sweep angle, taper ratio) and can position a wing, or a plurality of wings, in any suitable configuration relative to a fuselage. In addition, a flap included in a deflected slip stream wing system with coflow jet flow control can have any suitable structural configuration, such as multi-element flaps. Furthermore, alternative embodiments may include a wing, or plurality of wings, with other means of generating lift and stability, such as dedicated vertical thrust-generating rotors, tail rotors, and/or stabilizing propulsors.

In the embodiment illustrated, the fuselage 12 has a length 15 equal to about 6.55 meters, a width 17 equal to about 1.65 meters, a first set of wings 33′ has a first wingspan 19 equal to about 5.6 meters, and a second set of wings 35″ has a second wingspan 21 equal to about 8.4 meters. As used herein, the term “about” allows for a variation in a listed value between about 10% and about 50%. While particular dimensions have been provided relative to the illustrated example air transportation vehicle 8, it is to be understood that the deflected slip stream wing systems with coflow jet flow control 10 described herein can be included on any suitable vehicle having any suitable structural arrangement and dimensions.

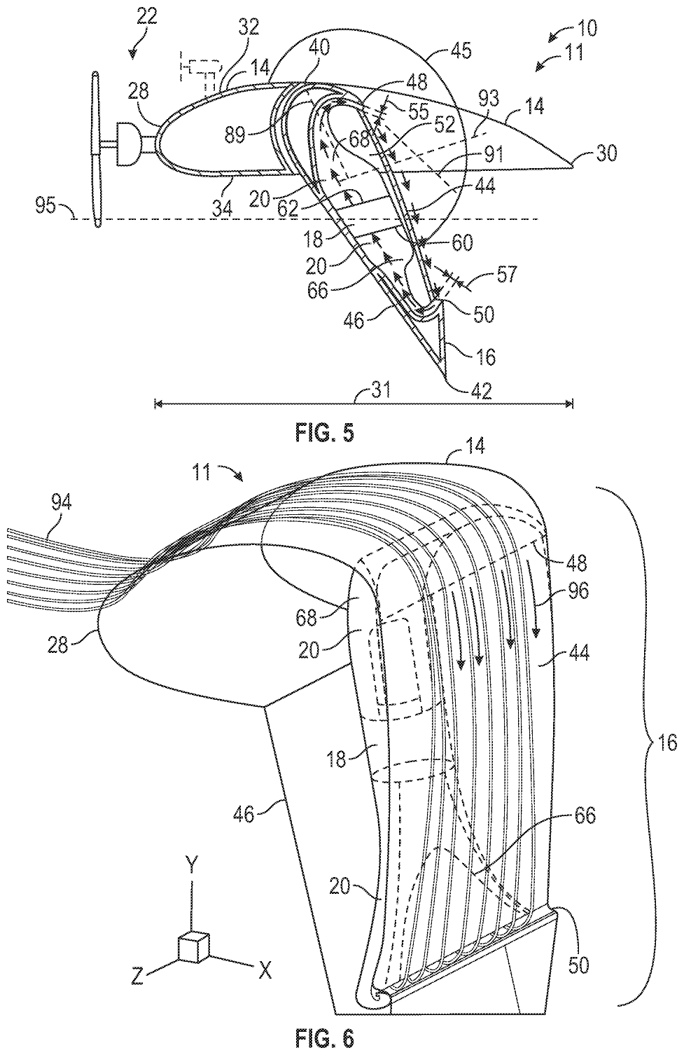

The wingbox 14 has a root 24, a tip 26, a leading edge 28, a trailing edge 30, a chord length 31, a top surface 32, and a bottom surface 34. The root 24 of the wingbox 14 is attached to the fuselage 12. The chord length 31, as shown in FIG. 5, extends from the leading edge 28 of the wingbox 14 to the trailing edge 30 of the wing 14.

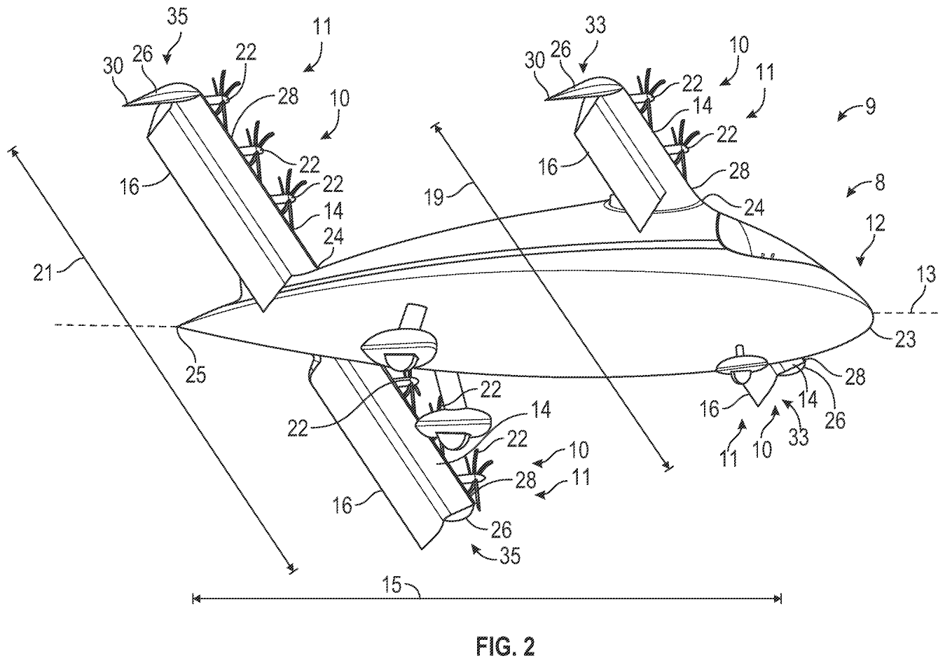

The flap 16 is moveably attached to the wingbox 14 and has a chord 39, a leading edge 40, a trailing edge 42, a chord length 41, a top surface 44, a bottom surface 46, an injection opening 48, a suction opening 50, and a channel 52. The flap 16 is moveable (e.g., continuously or discretely) between a first position, as shown in FIGS. 1 and 4, and a second position, as shown in FIGS. 2 and 5. The chord 39 extends from the leading edge 40 and the trailing edge 42.

As shown in FIG. 4, the flap 16 is disposed at a first angle 43 relative to the wingbox 14 when the flap 16 is in the first position. As shown in FIG. 5, the flap 16 is disposed at a second angle 45 relative to the wingbox 14 when the flap 16 is in the second position. The second angle 45 is greater than the first angle 43 (e.g., is greater than the first angle 43 by between about 1 degree and about 100 degrees). Stated otherwise, the deflection angle is the angle between the chord of the flap 16 in the first position and the chord of the flap 16 in the second position. The deflection angle is between about 1 degree and about 100 degrees. Alternative embodiments, however, can include a flap that can deflect at a negative angle such that a second angle is less than a first angle (e.g., is less than the first angle by between about 0 degrees and about −90 degrees), which can be used as an air break at landing to slow down an air transportation vehicle. In embodiments in which it is desired to utilize the deflected slip stream wing system with coflow jet flow control 10 to achieve VTOL, the second angle 45 is greater than the first angle 43 by more than 70 degrees (e.g., is greater than the first angle 43 by more than between about 70 degrees and about 90 degrees). Alternatively stated, the deflection angle is between about 70 degrees and about 90 degrees. In embodiments in which it is desired to utilize the deflected slip stream wing system with coflow jet flow control 10 to achieve STOL, the second angle 45 is greater than the first angle 43 by less than 70 degrees (e.g., is greater than the first angle 43 by between about 30 degrees and about 50 degrees). Alternatively stated, the deflection angle is less than 70 degrees (e.g., is between about 30 degrees and about 50 degrees). In embodiments in which it is desired to utilize the deflected slip stream wing system with coflow jet flow control 10 to achieve conventional takeoff and landing (CTOL), the second angle 45 is greater than the first angle 43 by less than 30 degrees. Alternatively stated, the deflection angle is less than 30 degrees. While particular angles have been described as being suitable for VTOL, STOL, and CTOL, a deflected slip stream wing system with coflow jet flow control can utilize any suitable angle between a wing and a flap to achieve VTOL, STOL, and/or CTOL and selection of a suitable angle can be based on various considerations, such as the structural arrangement of a wing and/or the structural arrangement of a flap.

The chord length 41 of the flap 16 extends from the leading edge 40 of the flap 16 to the trailing edge 42 of the flap 16. A chord length of a flap can have any suitable length and selection of a suitable length can be based on various considerations, including the intended use of a deflected slip stream wing system with coflow jet flow control of which the flap is a component. Examples of chord lengths considered suitable for a flap include chord lengths that are between about 40% and about 70% of a chord length of a wing, chord lengths that are greater than, less than, or about 40% of a chord length of a wing, chord lengths that are greater than, less than, or about 70% of a chord length of a wind, and any other chord length considered suitable for a particular embodiment.

The injection opening 48 is disposed between the leading edge 40 of the flap 16 and the suction opening 50. The suction opening 50 is disposed between the injection opening 48 and the trailing edge 42 of the flap 16. The channel 52 extends from the injection opening 48 to the suction opening 50 internal to the flap. In the illustrated embodiment, the injection opening 48 is disposed on an injection opening axis 49. The injection opening axis 49 is disposed at an angle 51 relative to a hypothetical axis 53 that is disposed horizontally. The angle 51 can be any suitable angle when the flap 16 is in the first position, such as angles between about 45 degrees and about 90 degrees, or angles between about 70 degrees and 90 degrees. The angle 51 can be any suitable angle when the flap 16 is in the second position, such as angles between about 100 degrees and about 270 degrees, angles between about 135 degrees and about 180 degrees, or angles between about 160 degrees and 180 degrees. As shown in FIG. 5, the injection opening 48 has a height 55 measured on a hypothetical plane that is parallel to the lengthwise axis 13 of the fuselage 12. The height 55 of the injection opening 48 can be any suitable height, such as a height between about 0.2% and about 2% of the chord length 31 of the wingbox 14, or greater than, less than, or about 0.2% of the chord length 31 of the wingbox 14. As shown in FIG. 5, the suction opening 50 has a height 57 measured on a hypothetical plane that is parallel to the lengthwise axis 13 of the fuselage 12. The height 57 of the suction opening 48 can be any suitable height, such as a height between about 0.4% and about 3% of the chord length 31 of the wingbox 14, or greater than, less than, or about 0.4% of the chord length 31 of the wingbox 14.

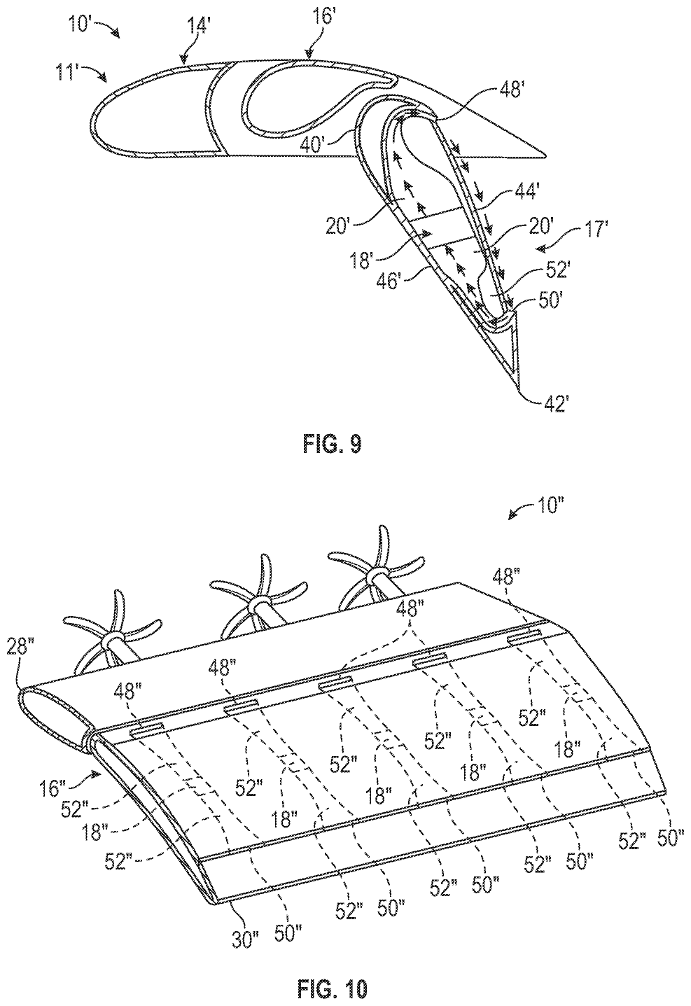

While the illustrated embodiment shows a single flap 16, a deflected slip stream wing system with coflow jet flow control can include any suitable number and type (e.g., double slotted, fowler) of flaps on a single wing, or multiple wings. For example, a plurality of flaps can be included along a span of a deflected slip stream wing system with coflow jet flow control (e.g., wing span) and/or along a chord of a deflected slip stream wing system with coflow jet flow control (e.g., wing chord, double slotted/plan flaps), each of which, or some of which, can include the structure, components, and/or features described herein relative to flap 16. For example, FIG. 9 illustrates an alternative embodiment of a deflected slip stream wing system with coflow jet flow control 10′. The deflected slip stream wing system with coflow jet flow control 10′ includes a wing 11′, a compressor 18′, a plurality of ducts 20′, and omits a propulsor. The wing 11′ includes a wingbox 14′, a first flap 16′, and a second flap 17′. The first flap 16′ and the second flap 17′ are included along the chord of the deflected slip stream wing system with coflow jet flow control 10′. The first flap 16′ and the second flap 17′ are each moveable between a first position, similar to the position of flap 16 shown in FIG. 4, and a second position, as shown in FIG. 9. The first flap 16′ is disposed between the wingbox 14′ and the second flap 17′. The first flap 16′ does not include the structure, components, and/or features described herein relative to flap 16. The second flap 17′ does include the structure, components, and/or features described herein relative to flap 16. Specifically, the second flap 17′ has a leading edge 40′, a trailing edge 42′, a top surface 44′, a bottom surface 46′, an injection opening 48′, a suction opening 50′, and a channel 52′. When a plurality of flaps are included, a first flap of the plurality of flaps can retract and/or extend at first rate that is different than, or the same as, a second rate at which a second flap of the plurality of flaps retracts and/or extends. Furthermore, a flap can have any suitable structural arrangement and be located at any suitable location relative to a wingbox. For example, a flap can have a span that is equal to, less than, or greater than the span of a wingbox (e.g., a flap can have a span equal to about 5% of a wingbox span, 20% of a wingbox span, 50% of a wingbox span, 90% of a wingbox span, or 100% of a wingbox span) and/or be centrally located relative to a wingbox, near a root of a wingbox, near a tip of a wingbox, and any other location considered suitable for a particular embodiment. In embodiments in which a flap does not extend along the entirety, or a majority, of a span of a wingbox, the portion of the span of the wingbox that does not include a flap can have any suitable structural arrangement, such as those described herein relative to a flap (e.g., first position, second position, position between the first and second positions).

In the illustrated embodiment, each compressor of the plurality of compressors 18 is disposed (e.g., entirely) within the channel 52 and is in communication with a suction duct 66 and an injection duct 68, as described in more detail herein. Each compressor 18 is moveable between an off state and an on state and has a suction port 60 and an injection port 62. It is considered advantageous to include a plurality of compressors 18 at least because the inclusion of a plurality of compressors provides a mechanism for compressing fluid passing through the plurality of ducts 20 and forming a plurality of jets of fluid 96 as fluid exits the injection opening 48, as described in more detail herein. A compressor of a plurality of compressors can be operatively connected to any suitable portion of a device, system, or component on which a deflected slip stream wing system with coflow jet flow control is disposed to provide power to the compressor (e.g., battery, electric motor) and to provide a mechanism for moving the compressor between the off state and the on state (e.g., one or more switches). Alternative embodiments can include a compressor that can vary the degree to which fluid is compressed through the ducts to which the compressor is attached. Further alternative embodiments can omit the inclusion of a compressor in a system, in a channel, or disposed between first and second ducts, such that flow can travel through a channel, or one or more ducts, via the pressure difference between a suction opening and an injection opening.

In the illustrated embodiment, each compressor of the plurality of compressors 18 is attached to the flap 16 and is positioned such that the suction port 60 is directed toward a first portion of the channel 52 that extends from the suction opening 50 to the compressor (e.g., the suction port 60 is directed toward the suction opening 50) and the injection port 62 is directed toward a second portion of the channel 52 that extends from the injection opening 48 to the compressor 18 (e.g., the injection port 62 is directed toward the injection opening 48). In the off state, each compressor of the plurality of compressors 18 does not draw any fluid through the ducts. Alternatively, some fluid may be drawn through the ducts, or in alternative embodiments a channel, via the pressure difference between the suction opening and the injection opening. In the on state, each compressor of the plurality of compressors 18 draws fluid through the suction opening 50 and a suction duct 66, through the compressor, and pushes fluid out of an injection duct 68 and the injection opening 48.

A compressor can be attached to a flap using any suitable technique or method of attachment and selection of a suitable technique or method of attachment between a compressor and a flap can be based on various considerations, including the material(s) that forms the compressor and/or the flap. Examples of techniques and methods of attachment considered suitable include welding, fusing, using adhesives, mechanical connectors, and any other technique or method considered suitable for a particular embodiment. While each compressor of the plurality of compressors 18 has been illustrated as directly attached to a flap, alternative embodiments can include one or more compressors that are indirectly attached to a flap.

A compressor included in a deflected slip stream wing system with coflow jet flow control can comprise any suitable device, system, or component capable of compressing a fluid and selection of a suitable compressor can be based on various considerations, such as the structural arrangement of a channel defined by a flap within which the compressor is disposed. Examples of compressors considered suitable to include in a deflected slip stream wing system with coflow jet flow control include electric pumps, pneumatic pumps, hydraulic pumps, micro-pumps, fans, electric fans, compressors, micro-compressors, vacuums, blowers, and any other compressor considered suitable for a particular embodiment.

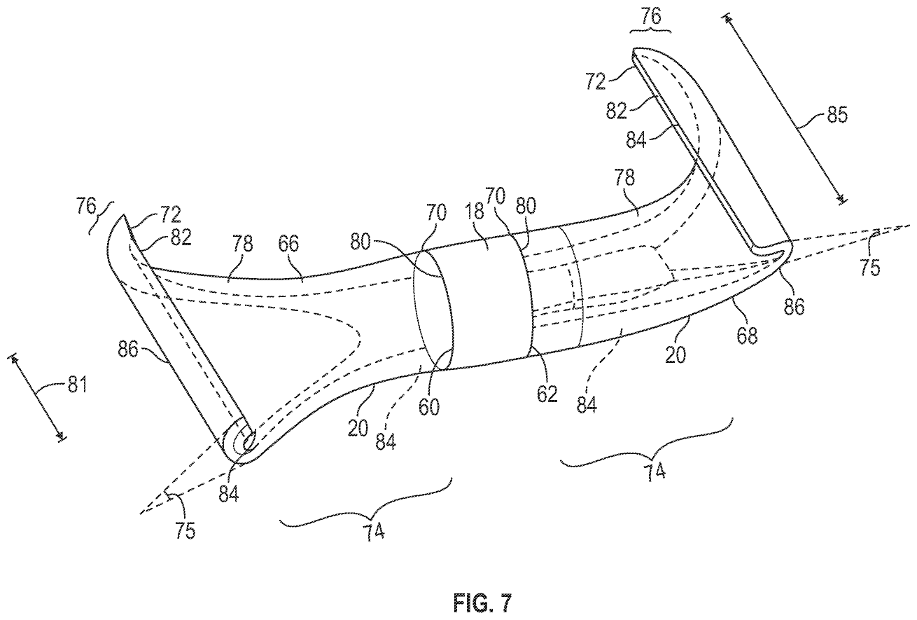

In the illustrated embodiment, the plurality of ducts 20 includes a set of suction ducts 66 and a set of injection ducts 68. Each duct of the plurality of ducts 20 is attached directly to the flap 16, is entirely disposed within the channel 52, and, as best shown in FIG. 7, has a first end 70, a second end 72, a first portion 74, a second portion 76, and a main body 78 that defines a first opening 80 at the first end 70, a second opening 82 at the second end 72, a passageway 84 that extends from the first opening 80 to the second opening 82, and a curve 86 between the first end 70 and the second end 72. Each suction duct 66 is attached to a suction port 60 of a compressor of the plurality of compressors 18 and extends from the compressor to the suction opening 50 such that the second end 72 of the suction duct 66 is disposed within the suction opening 50. Each injection duct 68 is attached to an injection port 62 of a compressor of the plurality of compressors 18 and extends from the compressor to the injection opening 48 such that the second end 72 of the injection duct 68 is disposed within the injection opening 48. The first portion 74 extends from the first end 70 toward the second end 72 and the second portion 76 extends from the second end 72 toward the first end 70. The first portion 74 is disposed at an angle 75 relative to the second portion 76 that is less than 90 degrees. However, other angles can be utilized, such as angles that are between about 80 degrees and about 100 degrees, between about 70 degrees and about 110 degrees, between about 45 degrees and about 80 degrees, between about 60 degrees and about 120 degrees, and any other angle considered suitable for a particular embodiment.

The first opening 80 has a first opening length 81, a first opening height 83, and a first opening cross-sectional area and the second opening 82 has a second opening length 85, a second opening height 87, and a second opening cross-sectional area that is less than the first opening cross-sectional area. The first opening length 81 is equal to the first opening height 83, is less than the second opening length 85, and is greater than the second opening height 87. The second opening height 87 is less than the second opening length 85, is less than the first opening length 81, and is less than the first opening height 83. The second opening height 87 is equal to between about 0.01% and about 100% of the first opening height 83. The second opening length 85 is equal to between about 10% of the first opening length 81 and about 10 times the first opening length 81. The second opening cross-sectional area can be equal to any suitable value, such as equal to between about 10% and about 100% of the first opening cross-sectional area, between about 0.01% and about 10% of the first opening cross-sectional area, between about 0.01% and 200% of the first opening cross-sectional area, and any other cross-sectional area considered suitable for a particular embodiment. In the illustrated embodiment, the length of the passageway 84 increases from the first end 70 to the second end 72 and the height of the passageway 84 decreases from the first end 70 to the second end 72. In the illustrated embodiment, the first opening 80 is centered relative to the second opening 82 such that the center of the first opening 80 is disposed on a plane 79 that extends through the entire passageway 84 and contains the center of the second opening 82. Alternative embodiments, however, can include a first opening that is offset relative to the center of a second opening such that the center of the first opening is disposed on a first plane that extends through the passageway and is disposed parallel to a second plane that contains the center of the second opening and extends through the passageway.

As shown in FIG. 7, the first opening 80 has a first structural configuration and the second opening 82 has a second structural configuration that is different than the first structural configuration. In the illustrated embodiment, the first opening 80 is circular and the second opening 82 is rectangular such that the cross-sectional configuration of the passageway 84 transitions from the first end 70 to the second end 72. While the first opening 80 has been illustrated as being circular and the second opening 82 has been illustrated as being rectangular, a first opening and a second opening of a duct can have any suitable structural configuration relative to one another. Selection of a suitable structural configuration for a first opening and a second opening of a duct can be based on various considerations, including the intended use of the deflected slip stream wing system with coflow jet flow control. Examples of structural configurations considered suitable for a first opening and/or a second opening of a duct include those that are the same, those that are different from one another, rectangular, square, circular, oval, elliptical, and/or any other structural arrangement considered suitable for a particular embodiment.

As shown in FIG. 4, each duct in the set of suction ducts 66 is configured to allow a fluid to pass through the passageway 84 from the second opening 82 to the first opening 80 such that the fluid enters the passageway 84 at the second end 72 along an axis 71 that is directed toward an axis 89 that extends through the first opening 80 and the first portion 74. In the illustrated embodiment, the suction ducts 66 are sized and configured to prevent fluid from traveling through channel 52 (e.g., such that fluid can only pass through suction ducts 66 to the plurality of compressors 18). Each duct in the set of injection ducts 68 is configured to allow a fluid to pass through the passageway 84 from the first opening 80 to the second opening 82 such that the fluid exits the passageway 84 at the second end 72 along an axis 91 that is directed toward a plane 93 that is orthogonal to the axis 89 and away from the second end 72 and the leading edge 40 of the flap 16.

While each duct in the plurality of ducts 20 has been illustrated as a separate member attached to the flap 16 and a compressor 18, a duct can be attached to a flap using any suitable technique or method of attachment. Selection of a suitable technique or method of attachment between a duct and a flap can be based on various considerations, such as the desired fluid flow through a duct. Examples of techniques and methods of attachment considered suitable between a duct and a flap and/or a duct and a compressor include welding, fusing, using adhesives, screws, mechanical connectors, and/or forming a duct as an integrated component of a flap and/or compressor. In the illustrated embodiment, each duct of the plurality of ducts 20 is directly attached to the flap 16 and a compressor 18. Alternative embodiments, however, can include one or more ducts that are indirectly attached to a flap and/or a compressor or that define the structure of a duct using the material forming a flap. While the deflected slip stream wing system with coflow jet flow control 10 has been illustrated as including a plurality of compressors 18 having a particular structural arrangement and a plurality of ducts 20 having a particular structural arrangement, a deflected slip stream wing system with coflow jet flow control can include any suitable number of compressors and ducts having any suitable structural arrangement. Selection of a suitable number of compressors and/or ducts to include in a deflected slip stream wing system with coflow jet flow control can be based on various considerations, including the intended use of the deflected slip stream wing system with coflow jet flow control. Examples of numbers of compressors considered suitable to include in a deflected slip stream wing system with coflow jet flow control include one, at least one, two, a plurality, three, four, five, more than five, more than ten, more than twenty, more than forty, and any other number considered suitable for a particular embodiment. Examples of numbers of ducts considered suitable to include in a deflected slip stream wing system with coflow jet flow control include zero, one, at least one, two, a plurality, three, four, five, more than five, more than ten, one for each compressor, two for each compressor, a suction duct and an injection duct for one or more compressors, or each compressor, and any other number considered suitable for a particular embodiment. For example, a deflected slip stream wing system with coflow jet flow control can include one or more injection ducts and omit the inclusion of any suctions ducts, or vice versa, or the type of duct included in the deflected slip stream wing system with coflow jet flow control could alternate along the length of the deflected slip stream wing system with coflow jet flow control. Alternatively, a deflected slip stream wing system with coflow jet flow control can omit the inclusion of a duct, or a plurality of ducts. For example, in these alternative embodiments, a compressor, or plurality of compressors, can be disposed within a channel defined by a flap. In these embodiments, a flap defines an injection opening, or a plurality of injection openings, a suction opening, or a plurality of suction openings, and a channel, or a plurality of channels. Each injection opening is disposed between the leading edge and a suction opening, or the plurality of suction openings. Each suction opening is disposed between the injection opening, or the plurality of injection openings, and the trailing edge. Each channel extends from an injection opening to a suction opening. A compressor is disposed within each channel. FIG. 10 shows an example of this alternative embodiment of a deflected slip stream wing system with coflow jet flow control 10″. As shown in FIG. 10, a compressor of a plurality of compressors 18″ is disposed within each channel 52″ defined by a flap 16″. The flap 16″ defines a plurality of injection openings 48″, a plurality of suction openings 50″, and a plurality of channels 52″. Each injection opening of the plurality of injection openings 48″ is disposed between the leading edge 28″ and the plurality of suction openings 50″. Each suction opening of the plurality of suction openings 50″ is disposed between the plurality of injection openings 48″ and the trailing edge 30″. Each channel of the plurality of channels 52″ extends from an injection opening of the plurality of injection openings 48″ to a suction opening of the plurality of suction openings 50″ and can have any suitable structural arrangement, such as those described herein relative to a duct, or a plurality of ducts.

With respect to the structural arrangement of a duct, alternative embodiments can include a duct that defines a bend, or another feature, to position a first portion of a duct at an angle relative to a second portion of a duct. While the deflected slip stream wing system with coflow jet flow control 10 has been illustrated as including a plurality of ducts 20 that are entirely disposed within the channel 52, a deflected slip stream wing system with coflow jet flow control can include any suitable number of ducts having any suitable portion disposed within a channel. Selection of a suitable position to locate a duct can be based on various considerations, including the desired fluid flow through a deflected slip stream wing system with coflow jet flow control. Examples of suitable positions to locate a duct include those in which the entire duct is positioned within a channel, a portion of a duct is positioned within a channel (e.g., the second end is disposed in an environment exterior to a channel), and any other position considered suitable for a particular embodiment.

Each propulsor of the plurality of propulsors 22 is disposed on the wingbox 14 between the root 24 and the tip 26, on the leading edge 28 of the wingbox 14 such that each propulsor is upstream of the leading edge of the wing, and has an off state and an on state. In an on state, the power provided by a propulsor can be modified between various magnitudes. Each propulsor of the plurality of propulsors 22 is positioned (e.g., aligned) relative to the flap 16 such a portion of fluid accelerated by each propulsor of the plurality of propulsors 22 is directed toward, and contacts (e.g., the bottom surface 46 of the flap 16), the flap 16 when the propulsor is in the on state and the flap 16 is in the second position. In addition, each propulsor of the plurality of propulsors 22 is positioned (e.g., aligned) relative to the flap 16 such that a portion of fluid accelerated by each propulsor of the plurality of propulsors 22 is deflected by the wingbox 14 and the flap 16. For example, when the propulsor is in the on state and the flap 16 is in the second position, each propulsor of the plurality of propulsors 22 is aligned relative to the flap 16 such a portion of fluid accelerated by each propulsor of the plurality of propulsors 22 is directed toward, and contacts, the bottom surface 34 of the wingbox 14 and the bottom surface 46 of the flap 16. In some embodiments, each propulsor is positioned (e.g., aligned) relative to a wing and a flap such that a portion of fluid accelerated by each propulsor immerses the flaps upper surface. As shown in FIG. 5, a portion of a propulsor of the plurality of propulsors 22 and a portion of the flap 16 is disposed on an axis 95 that is parallel to the lengthwise axis 13 of the fuselage. However, in alternative embodiments, a portion of a propulsor and a portion of a flap can be disposed on an axis that is disposed at an angle relative to a lengthwise axis of a fuselage that is not parallel to the lengthwise axis of the fuselage. In the illustrated embodiment, each propulsor of the plurality of propulsors 22 is a propeller.

While each deflected slip stream wing system with coflow jet flow control 10 has been illustrated as including a plurality of propulsors 22 located at specific locations on a wing, a deflected slip stream wing system with coflow jet flow control can include any suitable number and type of propulsors positioned at any suitable location on a wing. Selection of a suitable number and type of propulsors, and position to locate a propulsor, can be based on various considerations, including the intended use of the vehicle on which the deflected slip stream wing system with coflow jet flow control is included. Examples of suitable propulsors considered suitable to include in a deflected slip stream wing system with coflow jet flow control include propellers, jet engines, unducted fans, ducted fans, open rotors, open rotors with counter-rotating blades, electronic propulsion devices, propulsors with electric motors, any device or system that generates thrust and pulls airflow, and any other propulsor considered suitable for a particular embodiment. Examples of positions considered suitable to locate a propulsor on a wing include on a leading edge of a wing, upstream of a leading edge of a wing, between a leading edge and a trailing edge of a wing and on a top surface of a wing (e.g., as shown in FIGS. 4 and 5 in broken lines), between a leading edge of a wing and a flap and on a top surface of a wing (e.g., as shown in FIGS. 4 and 5 in broken lines), between a leading edge and a trailing edge of a wing and on a bottom surface of a wing, between a leading edge of a wing and a flap and on a bottom surface of a wing, such that each propulsor in a plurality of propulsors is distributed along a wing (e.g., equally space from an adjacent propulsor of the plurality of propulsors, overlapped, or variably spaced from an adjacent propulsor of the plurality of propulsors), combinations of the positions described herein, and any other location considered suitable for a particular embodiment. Examples of numbers of propulsors considered suitable to include on a wing include zero, one, at least one, two, a plurality, three, four, five, six, seven, eight, more than eight, and any other number considered suitable for a particular embodiment. For example, a deflected slip stream wing system with coflow jet flow control can omit the inclusion of a propulsor and a propulsor can be positioned on another portion of an air transportation vehicle and/or aircraft (e.g., nose of fuselage and/or tail of fuselage, another wing). In these alternative embodiments, a portion of fluid accelerated by a propulsor is directed toward, and contacts (e.g., a bottom surface of a flap, a top surface of a flap, a bottom surface of a wind, and/or a top surface of a wing), the wing and/or flap and/or immerses a top surface of a flap that includes the deflected slip stream wing system with coflow jet flow control when the propulsor is in the on state and the flap is in the second position. In embodiments in which a propulsor, or plurality of propulsors, is disposed between a leading edge of a wing and a flap and on a top surface of a wing, each propulsor is positioned (e.g., aligned) relative to the flap such a portion of fluid accelerated by each propulsor is directed toward and flows over the flap when the propulsor is in the on state and the flap is in the first and/or second position. In addition, when each propulsor is positioned (e.g., aligned) relative to the flap such that a portion of fluid accelerated by each propulsor is deflected by the wing and the flap.

It is considered advantageous to include one or more propulsors in a deflected slip stream wing system with coflow jet flow control included on an air transportation vehicle, such as those described herein, to increase the lift, reduce the weight, increase the efficiency, and reduce the noise relative to conventional direct vertical takeoff and landing air transportation vehicles. For example, the inclusion of the plurality of deflected slip stream wing systems with coflow jet flow control 10 on air transportation vehicle 8 generates greater lift coefficient relative to previously-developed VTOL vehicles that do not include a deflected slip stream wing system with coflow jet flow control. In addition, the inclusion of a deflected slip stream wing system with coflow jet flow control on a vehicle assists with the generation of lift during takeoff, landing, transition between hover and cruise, and/or while cruising, which increases efficiency throughout the entire flight. Previous deflected slip stream aircraft have suffered from loss of lift when propellers re-ingested their slipstreams, which were reflected off of the ground. By including a distributed plurality of propulsors, the deflected slip stream wing systems with coflow jet flow control 10 described herein result in the mass flow required at any single propulsor being reduced and the mass flow being spread out over a greater area, reducing the amount of air deflected upward at any given propulsor location. In addition, the inclusion of a plurality of propulsors allows for use of smaller diameter propulsors, raising them further above the ground relative to single propulsor vehicles and reducing ground effect. Furthermore, use of propulsors with electric motors allows for overpowering the motors for short periods of time (e.g., 10-30 seconds) which, even if some flow were re-ingested into the propulsor while resting on the ground, would allow an aircraft to gain sufficient altitude without having to increase the maximum continuous power to the propulsor. Therefore, a light and more practical vehicle is produced.

While the air transportation vehicle 8 has been illustrated as including a plurality of deflected slip stream wing systems with coflow jet flow control 10, alternative embodiments can include any suitable number of deflected slip stream wing systems with coflow jet flow control on a vehicle. Examples of numbers of deflected slip stream wing systems with coflow jet flow control considered suitable to include on a vehicle include one, at least one, two, a plurality, three, four, more than four, one for each wing included on a vehicle, one for each flap included on a vehicle, and any other number considered suitable for a particular embodiment.

While the wing 11, the wingbox 14, and the flap 16 have been illustrated as having a particular structural arrangement, a wing, a wingbox, and a flap can have any suitable structural configuration and selection of a suitable structural configuration can be based on various considerations, including the intended use of a deflected slip stream wing system with coflow jet flow control. For example, a wing can include one or more flaps and/or slats on a leading edge to assist with directing airflow in a particular direction (e.g., toward flap that includes an injection opening, suction opening, channel, and/or a compressor). For example, a flap can include a first body portion and second body portion that are separate structures attached to one another (using any suitable technique or method of attachment, such as those described herein) to cooperatively define a suction opening. an injection opening, and a channel. Alternatively, a flap can include a first body portion and a second body portion that are integrated components such that they are formed as a single piece of material. Examples of suitable structural configurations for a wing, a wingbox, and/or flap, and other elements, features, and/or components, that can be included in a deflected slip stream wing system with coflow jet flow control described herein include those illustrated and described in U.S. patent application Ser. No. 17/331,997 by Zha and filed on May 27, 2021, which is incorporated by reference herein in its entirety, and/or U.S. patent application Ser. No. 16/421,872 by Zha and filed on May 24, 2019, which is incorporated by reference herein in its entirety. For example, a deflected slip stream wing system with coflow jet flow control, such as those described herein, can be combined with a fluid system, such as those described in the applications incorporated by reference, such that a fluid system is incorporated into a wing and deflected slip stream wing system with coflow jet flow control is incorporated into a flap. This allows for simultaneous use of a fluid system on a wing and a deflected slip stream wing system with coflow jet flow control on a flap (e.g., a first suction opening, first channel, and first injection opening on a wing and a second suction opening, second channel, and second injection opening on a flap). Alternative embodiments, such as those with a large wing, can include multiple sets of suction opening, channels, and injection openings on a wing.

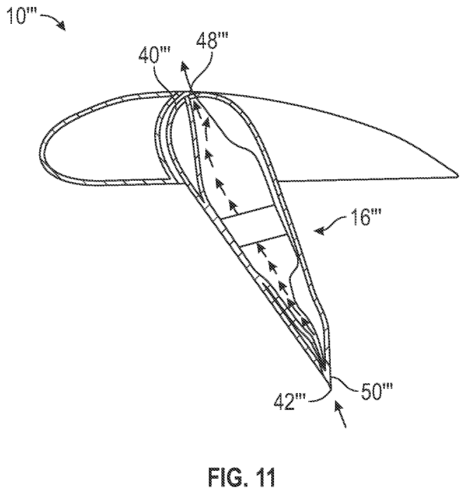

While the channel 52 has been illustrated as having a particular structural configuration and dimensions that vary along the length of the channel 52, a channel can have any suitable structural configuration and selection of a suitable structural configuration for a channel can be based on various considerations, such as the structural arrangement of a duct disposed within the channel. While the injection opening 48 and the suction opening 50 have been illustrated as being disposed at particular angles relative to the top surface 44 of the flap 16 and as being disposed at particular distances from the leading edge 40, an injection opening and a suction opening included in a deflected slip stream wing system with coflow jet flow control can be disposed at any suitable angle relative to a top surface of a flap, and can be disposed at any suitable distance from a leading edge of a flap. Selection of a suitable angle to position an injection opening and/or suction opening relative to a top surface of a flap and/or a suitable distance to position an injection opening and/or suction opening from a leading edge of a flap can be based on various considerations, such as the desired fluid flow across, or through, a deflected slip stream wing system with coflow jet flow control. Examples of angles considered suitable to orient an injection opening and/or a suction opening relative to a top surface of a flap include angles such that fluid entering a suction opening is tangential, or substantially tangential, to a top surface of the flap and/or such that fluid exiting an injection opening is tangential, or substantially tangential, to a top surface of a flap, angles between about 0 degrees and about 90 degrees relative to a top surface of a flap, and any other angle considered suitable for a particular embodiment. Examples of locations considered suitable to position an injection opening include at a leading edge, between a leading edge and a trailing edge and along a bottom surface of a flap (e.g., for slotted flaps), and any other location considered suitable for a particular embodiment. Examples of locations considered suitable to position a suction opening include at a trailing edge, between a leading edge and a trailing edge and along a bottom surface of a flap, and any other location considered suitable for a particular embodiment. FIG. 11 illustrates an example of an alternative deflected slip stream wing system with coflow jet flow control 10′ in which an injection opening 48′ is disposed at the leading edge 40′ of the flap 16′″ and the section opening 50′ is disposed at the trailing edge 42′″ of the flap 16′″.

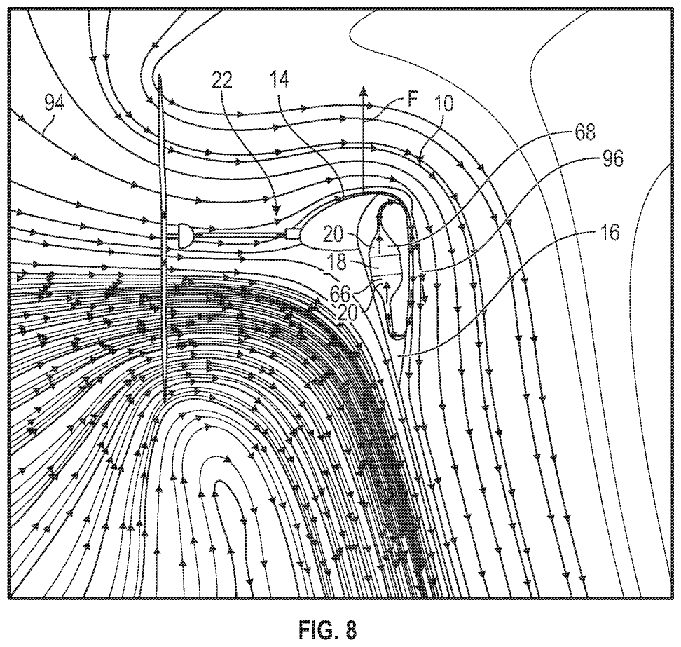

As shown in FIGS. 6 and 8, as the deflected slip stream wing system with coflow jet flow control 10 travels through a fluid, one or more propulsors of the plurality of propulsors 22 are in the on state, and one or more compressors of the plurality of compressors 18 is in the on state, the fluid flow 94 interacts with the deflected slip stream wing system with coflow jet flow control 10 such that the fluid, which in this example is air, travels around, and through, the deflected slip stream wing system with coflow jet flow control 10. When it is desired for the air transportation vehicle 8 to complete a VTOL or STOL, the flap 16 is moved to its second position, as shown in FIGS. 5, 6, and 8, each compressor of the plurality of compressors 18 is placed in the on state, and each propulsor of the plurality of propulsors 22 is placed in the on state such that a first portion of fluid is directed toward, and contacts, the bottom surface 46 of the flap 16 and a second portion of the fluid is directed over the wingbox 14 and the flap 16 (e.g., top surface 44 of the flap 16). The first portion of the fluid is directed toward the ground upon which the air transportation vehicle 8 is disposed and creates lift such that the air transportation vehicle 8 can achieve a VTOL and STOL. A portion of the second portion of the fluid travels over the wingbox 14 and, as a result of each compressor of the plurality of compressors 18 being placed in the on state, deflects downwardly over the top surface 44 of the flap and into the suction opening 50, through the set of suction ducts 66, is pressurized by the plurality of compressors 18, travels through the set of injection ducts 68, exits at the injection opening 48, and is injected into the fluid flow as a plurality of jets 96 over the top surface 44 of the flap 16. This arrangement creates a deflected slip stream generated by the plurality or propulsors 22, the plurality of compressors 18, the flap 16, and the plurality of jets 96, which generates vertical lift represented by the resultant force F, as shown in FIG. 8. The position of the injection opening 48, and the angle 51 at which it is disposed on the flap 16 such that the fluid exiting the injection opening 48 is tangential, or substantially tangential, to the top surface 44 of the flap 16 and directed downwardly toward the surface on which the air transportation vehicle 8 is positioned, increases the lift generated by the deflected slip stream wing system with coflow jet flow control 10. Depending on the number of ducts, compressors, and/or channels included in a deflected slip stream wing system with coflow jet flow control, alternative embodiments can form a single jet over a top surface of a flap. In the illustrated embodiment, the plurality of jets 96 of fluid is injected into the fluid at an angle that is substantially tangential to the top surface 44 of the flap 16 downstream of the injection opening 48. The one or more jets 96 are co-flow jets in that they each form a stream of fluid that is injected into a separate fluid, or fluid flow. However, alternative embodiments can include one or more jets that are not tangential to the top surface of a second body portion and are injected into a fluid at any suitable angle relative to a top surface of a flap.

When it is desired for the wingbox 14 and the flap 16 to be positioned in a cruise configuration, the flap 16 is moved to its first position, as shown in FIG. 4, some compressors of the plurality of compressors 18 (e.g., each compressor of the plurality of compressors 18, a portion of the compressors of the plurality of compressors 18), or none of the compressors of the plurality of compressors 18, are placed in the on or off state, and some propulsors of the plurality of propulsors 22 (e.g., each propulsor of the plurality of propulsors 22, a portion of the propulsors of the plurality of propulsors 22), or none of the propulsors of the plurality of propulsors 22, are placed in the on or off state such that a first portion of the fluid is directed under the wingbox 14 and the flap 16 (e.g., bottom surface 46 of the flap 16) and a second portion of the fluid is directed over the wingbox 14 and the flap 16 (e.g., top surface 44 of the flap 16). A portion of the second portion of the fluid travels into the suction opening 50, through the set of suction ducts 66, is pressurized by the plurality of compressors 18 when in the on state, travels through the set of injection ducts 68, exits at the injection opening 48, and is injected into the fluid flow as a plurality of jets 96 over the top surface 44 of the flap 16. Depending on the number of ducts, compressors, and/or channels included in a deflected slip stream wing system with coflow jet flow control, alternative embodiments can form a single jet over a top surface of a flap. In the illustrated embodiment, the plurality of jets 96 of fluid is injected into the fluid at angle that is substantially tangential to the top surface 44 of the flap 16 downstream of the injection opening 48. The one or more jets 96 are co-flow jets in that they each form a stream of fluid that is injected into a separate fluid, or fluid flow. This arrangement creates a slip stream generated by the plurality or propulsors 22, the wingbox 14, the flap 16, and the plurality of jets 96, in which the resultant force F is rotated horizontally. However, alternative embodiments can include one or more jets that are not tangential to the top surface of a second body portion and are injected into a fluid at any suitable angle relative to a top surface of a flap.

While the examples provided herein have described use a propulsor to create first and second portions of fluid traveling over the wingbox 14 and the flap 16, in alternative embodiments, a first portion of fluid could be accelerated using a first set of propulsors and a second portion of fluid can be accelerated using a second set of propulsors.

In embodiments in which the plurality of deflected slip stream wing systems with coflow jet flow control include tandem wings, the tandem wing configuration has a certain static stability margin for its yaw, rolling, and pitching moments. Beyond the static stability, the yaw can be controlled by adjusting the output of the distributed plurality of propulsors 22 and the output of the plurality of compressors 18 at different points along the span of the left wings and the right wings, or a left wing and a right wing in embodiments that include only a left wing and a right wing, or one of the wings to produce different thrust or drag that generates a yaw moment. For rolling control, the output of the distributed propulsors 22 and embedded compressors 18 at different points along the span of the left wings and the rights wings, or a left wing and a right wing in embodiments that include only a left wing and a right wing, or one of the wings can be adjusted to produce different lift that generates rolling moment. For pitching control, a flap of a front wing or a rear wing can be deflected with different angles to generate a pitching moment. These flight control methods also apply to any aircraft that includes a deflected slip stream wing system with coflow jet flow control 10, such as those that include tandem wings, single wings, double deck wings, connected wings, box wings, flying wings, and ring wings.

The deflected slip stream wing systems with coflow jet flow control 10 described herein are considered advantageous at least because vehicles that include a flap that omits a suction opening, an injection opening, a channel, a compressor, a plurality of compressors, and/or a plurality of ducts are unable to deflect the fluid flow over a top surface of a flap when the flap is in the second position and the vehicle is attempting VTOL, STOL, or super-STOL. In these situations, the fluid becomes detached from the wing and flap and reduces the overall lift being generated for VTOL, STOL, or super-STOL. The inclusion of a plurality of propulsors 22 (e.g., distributed propulsion system), a suction opening, an injection opening, a channel, a plurality of ducts, and/or a plurality of compressors 18 (e.g., micro-compressors) embedded within the flap 16, along the span of the flap 16 increases the deflection of fluid when the flap 16 is in the second position. The inclusion of a deflected slip stream wing system with coflow jet flow control increases efficiency during cruise flight, provides for a smooth transition to/from vertical flight, and reduces community noise relative to previously-developed VTOL technology. Furthermore, the inclusion of a deflected slip stream wing system with coflow jet flow control allows for a vehicle to operate with higher payload capacity, less energy, and/or at extended ranges.

A deflected slip stream wing system with coflow jet flow control can include a suction opening, an injection opening, a channel, a plurality of compressors, a plurality of ducts, and a plurality of propulsors that are distributed along the entire span of the respective wing and/or flap, or that extend over only a portion, or multiple portions, of the span of the respective wing and/or flap. Each compressor 18 and propulsor 22 can be powered independently via a separate bus to ensure high redundancy and safety. Alternatively, a plurality of compressors and a plurality of propulsors 22 can be powered as a group. Furthermore, in embodiments in which the deflected slip stream wing systems with coflow jet flow control 10 described herein are utilized on vehicles completing CTOL, the deflected slip stream wing systems with coflow jet flow control 10 provide a mechanism for saving energy and extending the range of the vehicle (e.g., by being used during cruise).

The wing 11, the wingbox 14, the flap 16, the plurality of compressors 18, the plurality of ducts 20, the plurality of propulsors 22, and any other feature, element, or component described herein and included in the deflected slip stream wing system with coflow jet flow control 10 can be formed of any suitable material and manufactured using any suitable technique. Selection of a suitable material to form a wing, a wingbox, a flap, a compressor, a duct, a propulsor, and any other feature, element, or component described herein and included in a deflected slip stream wing system with coflow jet flow control and a suitable technique to manufacture a wing, a wingbox, a flap, a compressor, a duct, a propulsor, and any other feature, element, or component described herein and included in a deflected slip stream wing system with coflow jet flow control can be based on various considerations, including the intended use of the deflected slip stream wing system with coflow jet flow control. Examples of materials considered suitable to form a wing, a wingbox, a flap, a compressor, a duct, and/or a propulsor, and/or any other feature, element, or component described herein include conventional materials, metals, steel, aluminum, alloys, plastics, combinations of metals and plastics, composite materials, and any other material considered suitable for a particular embodiment. Examples of methods of manufacture considered suitable to manufacture a wing, a wingbox, a flap, a compressor, a duct, and/or a propulsor, and/or any other feature, element, or component described herein include conventional methods and techniques, injection molding, machining, 3D printing, and/or any other method or technique considered suitable for a particular embodiment.

Any of the herein described examples of deflected slip stream wing systems with coflow jet flow control, and any of the features described relative to a particular example of a deflected slip stream wing system with coflow jet flow control, can be included along a portion, portions, or the entirety, of the span of a flap. For example, any of the herein described embodiments can be combined in any suitable manner and include any of the features, devices, systems, and/or components described in U.S. patent application Ser. No. 17/331,997 by Zha and filed on May 27, 2021, which is incorporated by reference herein in its entirety, and/or U.S. patent application Ser. No. 16/421,872 by Zha and filed on May 24, 2019, which is incorporated by reference herein in its entirety. For example, any of the herein described embodiments can omit the inclusion of one or more ducts, be included on a single wing aircraft systems, and/or can be included on a single wing aircraft system with control surfaces of elevators, canards, and a rudder.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular arrangement of elements disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. A deflected slip stream wing system with coflow jet flow control for an aircraft comprising:
a wingbox having a root and a tip;
a flap moveably attached to the wingbox and having a leading edge, a trailing edge, an injection opening, a suction opening, and a channel, the channel extending from the injection opening to the suction opening; and
a compressor disposed within the channel.

2. The deflected slip stream wing system of claim 1, further comprising a propulsor disposed on the wingbox between the root and the tip, the propulsor having an off state and an on state.

3. The deflected slip stream wing system of claim 2, wherein when in the on state, the propulsor is aligned relative to the flap such that fluid accelerated by the propulsor contacts the flap.

4. The deflected slip stream wing system of claim 2, wherein the flap has a bottom surface extending from the leading edge of the flap to the trailing edge of the flap; and
wherein in the on state, the propulsor is aligned relative to the flap such that fluid accelerated by the propulsor contacts the bottom surface of the flap.

5. The deflected slip stream wing system of claim 2, further comprising a fuselage having a lengthwise axis; and
wherein a portion of the propulsor and a portion of the flap are disposed on an axis that is parallel to the lengthwise axis of the fuselage.

6. The deflected slip stream wing system of claim 2, wherein the propulsor comprises a plurality of propulsors disposed on the wingbox between the root and the tip, each propulsor of the plurality of propulsors having an off state and an on state, when in the on state each propulsor of the plurality of propulsors aligned relative to the flap such that fluid accelerated by each propulsor of the plurality of propulsors contacts the flap.

7. The deflected slip stream wing system of claim 2, wherein the propulsor comprises a propeller.

8. The deflected slip stream wing system of claim 2, wherein the wingbox has a leading edge; and
wherein the propulsor is disposed on the wingbox between the leading edge of the wingbox and the flap.

9. The deflected slip stream wing system of claim 2, wherein the wingbox has a leading edge;
and wherein the propulsor is disposed on the wingbox and upstream of the leading edge of the wingbox.

10. The deflected slip stream wing system of claim 2, wherein when in the on state, the propulsor is aligned relative to the flap such that fluid accelerated by the propulsor is deflected by the wingbox and the flap.

11. The deflected slip stream wing system of claim 1, wherein the flap is moveable relative to the wingbox between a first position and a second position, the flap disposed at a first angle relative to the wingbox in the first position and disposed at a second angle relative to the wingbox in the second position, the second angle being greater than the first angle by more than 70 degrees.

12. The deflected slip stream wing system of claim 1, wherein the flap is moveable relative to the wingbox between a first position and a second position, the flap disposed at a first angle relative to the wingbox in the first position and disposed at a second angle relative to the wingbox in the second position, the second angle being greater than the first angle by less than 70 degrees.

13. The deflected slip stream wing system of claim 1, wherein the flap is moveable relative to the wingbox between a first position and a second position, the flap disposed at a first angle relative to the wingbox in the first position and disposed at a second angle relative to the wingbox in the second position, the second angle being greater than the first angle by between about 30 degrees and about 50 degrees.

14. The deflected slip stream wing system of claim 1, wherein the flap is moveable relative to the wingbox between a first position and a second position, the flap disposed at a first angle relative to the wingbox in the first position and disposed at a second angle relative to the wingbox in the second position, the second angle being greater than the first angle by less than 30 degrees.

15. The deflected slip stream wing system of claim 1, wherein the flap is moveable relative to the wingbox between a first position and a second position; and
wherein the injection opening is disposed on an injection opening axis, the injection opening axis disposed at an angle relative to a hypothetical axis that is disposed horizontally, the angle being between about 45 degrees and about 90 degrees when the flap is in the first position.

16. The deflected slip stream wing system of claim 1, wherein the compressor has an on state and an off state, when the compressor is in the on state fluid enters the suction opening, is compressed by the compressor, and exits the injection opening substantially tangential to the flap.

17. The deflected slip stream wing system of claim 1, wherein the flap has a plurality of injection openings, a plurality of suction openings, and a plurality of channels, each injection opening of the plurality of injection openings disposed between the leading edge and the plurality of suction openings, each suction opening of the plurality of suction openings disposed between the plurality of injection openings and the trailing edge, each channel of the plurality of channels extending from an injection opening of the plurality of injection openings to a suction opening of the plurality of suction openings; and
wherein the compressor comprises a plurality of compressors, a compressor of the plurality of compressors disposed within each channel of the plurality of channels.

18. The deflected slip stream wing system of claim 1, wherein the injection opening is disposed between the leading edge and the suction opening; and
wherein the suction opening is disposed between the injection opening and the trailing edge.

19. A deflected slip stream wing system with coflow jet flow control for an aircraft comprising:
a wingbox having a root and a tip;
a flap moveably attached to the wingbox and having a leading edge, a trailing edge, an injection opening, a suction opening, a channel, and a bottom surface, the injection opening disposed between the leading edge and the suction opening, the suction opening disposed between the injection opening and the trailing edge, the channel extending from the injection opening to the suction opening, the bottom surface extending from the leading edge to the trailing edge;
a compressor disposed within the channel and having an on state and an off state;
a suction duct attached to the compressor;
an injection duct attached to the compressor; and
a propulsor disposed on the wingbox between the root and the tip, the propulsor having an off state and an on state, when in the on state the propulsor aligned relative to the flap such that fluid accelerated by the propulsor contacts the bottom surface of the flap;
wherein when the compressor is in the on state fluid enters the suction opening, enters the suction duct, is compressed by the compressor, enters the injection duct, and exits the injection opening substantially tangential to the flap.

20. A deflected slip stream wing system with coflow jet flow control for an aircraft comprising:
a wingbox having a root and a tip;
a flap moveably attached to the wingbox and having a leading edge, a trailing edge, an injection opening, a suction opening, a channel, and a bottom surface, the flap moveable relative to the wingbox between a first position and a second position, the flap disposed at a first angle relative to the wingbox in the first position and disposed at a second angle relative to the wingbox in the second position, the second angle being greater than the first angle by more than 70 degrees, the injection opening disposed between the leading edge and the suction opening, the suction opening disposed between the injection opening and the trailing edge, the channel extending from the injection opening to the suction opening, the bottom surface extending from the leading edge to the trailing edge;
a compressor disposed within the channel and having an on state and an off state;
a suction duct attached to the compressor;
an injection duct attached to the compressor; and
a plurality of propulsors disposed on the wingbox between the root and the tip, each propulsor of the plurality of propulsors having an off state and an on state, when in the on state each propulsor of the plurality of propulsors aligned relative to the flap such that fluid accelerated by each propulsor of the plurality of propulsors contacts the bottom surface of the flap;
wherein when the compressor is in the on state, fluid enters the suction opening, enters the suction duct, is compressed by the compressor, enters the injection duct, and exits the injection opening substantially tangential to the flap.
